(19) United States
(12) Patent Application Publication
(10) Pub. No.: US 2023/0182082 A1
(43) Pub. Date: Jun. 15, 2023

(54) METHOD AND SYSTEM FOR FILTER WITH IMPROVED FLUSHING

(71) Applicant: ENTEGRIS, INC., Billerica, MA (US)

(72) Inventors: Barry Lee Gregerson, Deephaven, MN (US); Adam Lane Baker, Lowell, MA (US)

(21) Appl. No.: 18/079,745

(22) Filed: Dec. 12, 2022

Related U.S. Application Data
(60) Provisional application No. 63/289,955, filed on Dec. 15, 2021.

(51) Int. Cl. B01D 63/06

(52) U.S. Cl. CPC B01D 63/06; B01D 2313/16; B01D 2313/19; B01D 2313/21; B01D 2313/086; B01D 2313/201; B01D 2315/08

(57) ABSTRACT

A filter includes a housing having an interior space, in which the housing has at least one opening end. The filter further includes a membrane disposed within the housing that has a length that extends along a length direction of the housing, and a baffle provided at least in the interior space of the housing. The baffle includes at least two baffle partitions that extend along at least a portion of the length of the membrane to divide the interior space of the housing into at least a first portion and a second portion so that when a fluid is supplied to the filter, the fluid is directed to first flow in the first portion and then to the second portion.

### FIELD OF THE INVENTION

The present disclosure generally relates to a fluid-processing filter and method of using the filter.

### BACKGROUND

Fluids used in manufacturing, for example in the semiconductor manufacturing industry, often flow through multiple filters to remove contaminants or unwanted materials from the fluid before the fluid is dispensed. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use to remove particles and bacteria from therapeutic solutions in the pharmaceutical industry, to process ultrapure aqueous and organic solvent solutions for use in microelectronics and semiconductor processing, and for water purification processes.

To perform a filtration function, a filter includes a filter membrane that is responsible for removing the unwanted material. The filter membrane may, as required, be in the form of a flat sheet, which may be wound (e.g., spirally), or pleated, etc. The filter membrane may alternatively be in the form of hollow fibers. The filter membrane can be contained within a housing so that fluid that is being filtered enters through a filter inlet and is required to pass through the filter membrane before passing through a filter outlet.

### SUMMARY

Disclosed herein is a filter comprising, consisting essentially of, or consisting of: a housing having an interior space, the housing including at least opening; a membrane disposed within the housing that has a length that extends along a length direction of the housing, and a baffle provided at least in the interior space of the housing. The baffle includes at least two baffle partitions that extend along at least a portion of the length of the membrane to divide the interior space of the housing into at least a first portion and a second portion so that when a fluid is supplied to the filter, the fluid is directed to first flow in the first portion and then to the second portion.

In an embodiment, a filter housing, includes an inlet end; an outlet end formed on an opposite end of the housing than the inlet end; an interior space; and a baffle. The baffle is provided at least in the interior space of the housing and at the inlet end, in which the baffle includes at least two baffle partitions that extend along at least a portion of a length of the filter housing to divide the interior space of the housing into at least a first portion and a second portion so that when a fluid is supplied to the filter housing, the fluid is directed to first flow along the first portion and then to the second portion.

In an embodiment, a method of filtering a fluid, includes introducing the fluid into a filter through an inlet. The method also includes directing the fluid through a baffle formed in an interior of a housing of the filter, the baffle including at least two baffle partitions that extend along at least a portion of the length of the membrane to divide an interior of the housing into at least a first portion and a second portion and passing the fluid through the baffle and the at least two baffle portions so that the fluid is directed to first flow in the first portion and then to the second portion. The fluid is passed through a membrane of the filter to an outlet.

### BRIEF DESCRIPTION OF THE DRAWINGS

The disclosure may be more completely understood in consideration of the following description of various illustrative embodiments in connection with the accompanying drawings

FIG. 1 is a cross-section view of an exemplary filter according to an embodiment.

FIGS. 2A and 2B are exploded views of the exemplary filter.

FIG. 3 is an exploded view of another exemplary filter according to an embodiment.

FIGS. 4A-4C are perspective and cross-sectional views of a filter according to another exemplary embodiment.

FIGS. 5A-5B are perspective and cross-sectional views of a filter according to yet another exemplary embodiment.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

Like reference numbers refer to like parts throughout.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

In the field of filtration, improved flow dynamics of the fluid within the filter is an important feature for a number of different applications, for example, in manufacturing, medical, pharmaceutical uses, or the like. For example, in the field of semiconductor manufacturing, the control of particulate contaminants in a filtration process requires the use of filters having membranes that remove submicron particles, for example, to have less than 5 ppb level of contaminants. It is understood that any particle that is deposited on a semiconductor wafer produces a defect when the particle is sufficiently large. Typically, in the semiconductor industry, failed defects can be produced by particles as small as about one tenth of the smallest features of the semiconductor chip. Therefore, controlling contamination improves manufacturing yield and reliability by reducing wafer defect rates.

Disclosed herein are filters that include a baffle for dividing the interior space of a filter housing into at least a first portion and a second portion and directing the flow of fluid in the filter housing. The baffle is designed to improve the flow pattern of a fluid by creating a circular flow path in the filter housing to remove or reduce low flow or dead zones in the filter, e.g., flows that are less than about 0.05 cm/sec. By creating the circular flow path in the filter housing, it was surprisingly found that the improvement of the distribution and flow of the fluid improves the exchange of chemistries of the filter membrane, which not only improves the flushing and the cleaning of the filter during the preparation of the filter, but also improves the residence time of the fluid during use of the filter, e.g., lowers residence time of the fluid. For example, without being bound to a theory, during preparing of a filter, a filter having low flow or dead zones may not receive the necessary flow contact of a fluid for proper cleaning and flushing and, therefore, requires subsequent flush-ups and/or takes additional time to meet any required cleanliness specifications of the filter. Additionally, during use of a filter, a filter having low flow or dead zones may leave residual chemistries or contaminants in the low flow or dead zones, which may accumulate and/or provide areas of bacterial growth, and/or for time sensitive reactive chemistries, not have the proper residence time for use of the time sensitive reactive chemistries, and not utilize the entirety of the filter membrane. On the other hand, the filter having the baffle as disclosed herein not only improves the residence time of the fluid and lower or eliminate the accumulation of residual chemistries or contaminants during use since low flow or dead zones are reduced or eliminated, but also improves the preparation of the filter to remove a potential source of contamination in the semiconductor manufacturing process, e.g., the filter having the baffle can be conditioned, e.g., cleaned and/or flushed, to have low contamination.

It is appreciated that the filter as discussed herein is not limited to specific types of filter designs. Rather, it is appreciated that the disclosure discussed herein can be used with many different designs of filters, for example, in liquid filtration using disposable single use filters or filters having replaceable filter cartridges which can include a filter membrane, a core, a housing, or a combination thereof. In an embodiment, the filter can be used to filter the fluid from one end of the filtration module to the other end. In this type of filter, the feed and permeate connections are located at opposite ends of the filter thereby forcing the liquid flow to move from one end to the other. This flow configuration is referred to as an in line flow configuration. The filter can be horizontally oriented or vertically oriented without significantly affecting the performance of the filter.

In another embodiment, the filter includes the feed and permeate ports that are horizontally oriented at the top of “head” end of the module on opposite sides thereof. Due to this shape, these modules are referred to as having a T configuration. The T configuration facilitates connection of the head to the remaining portion of the filtration module comprising the bowl and the filtration cartridge positioned within the bowl. In this filter design, the bowl and filtration cartridge include separate elements. Thus, when constructing the filtration module, the filtration cartridge and the bowl are separately secured to and sealed to the manifold head.

That is, it is appreciated that the baffle design of the present disclosure can be used for different types of filter designs, e.g., in-line, T-configuration, U-configuration, or the like, to improve the flow pattern of the fluid in the housing to remove or reduce dead or low flow zones in the filter. It is also appreciated that the baffle design can be used for either outside-in or inside out filter designs to improve the flow patterns within the filter without departing from the scope of the disclosure.

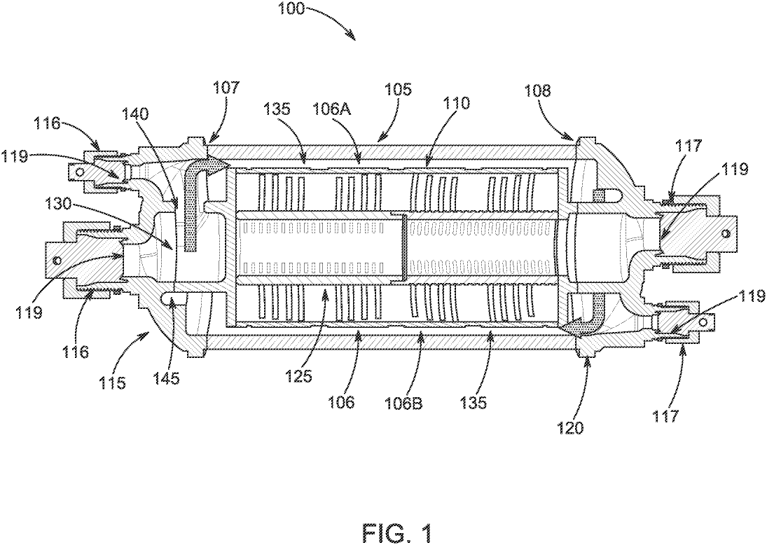

FIG. 1 is a cross-sectional view of an exemplary filter 100. The filter 100 can be a disposable filter for a single-use application in the semiconductor industry. The filter 100 includes a housing 105 having an interior space 106, in which the housing 105 includes at least one opening end, which can include an inlet end 107 and an outlet end 108 on an opposite end of the housing 105. The filter housing 105 is generally tubular or cylindrical but can be provided as any geometric shape that is suitable for the filtration process. The filter 100 further includes a membrane 110 disposed in the interior space 106 of the housing, a first end cap 115 connected to the inlet end 107 and a second end cap 120 connected to the outlet end 108. The first end cap 115 and the second end cap 120 can further define the interior space 106 of the housing. As shown, in FIG. 1, in some embodiments, the filter may also include a core 125 about which the membrane 110 is disposed. In other embodiments, the core 125 shown in FIG. 1 can be omitted. The interior space 106 can accommodate the different elements of the filter, for example, the membrane 110 and optionally the core 125, along with a fluid being filtered using the membrane 110.

The housing 105 may be made of any suitable moldable material typically used for filter housings, including, but not limited to, polypropylene, polyethylene, and perfluoroalkoxy alkanes (PFAs).

The membrane 110 can be a porous membrane and can have a pleated configuration. Suitable materials that can be used for the membrane include, as non-limiting examples, polytetrafluoroethylene (PTFE), polyethylene (including ultra high molecular weight polyethylene (UPE)), and polysulfone. The membrane has a first edge, a second edge, and a first (or interior) and a second (or exterior) surface extending between the first and second edges.

The core 125 may be a member that is surrounded by the membrane such that the membrane is disposed between the core 125 and the housing 105. In an embodiment, core 125 is tubular or cylindrical in shape. The core 125 can have a series of openings allowing fluid to pass between the membrane and a hollow center of the core 125. In embodiments, the core can be any suitable material including, as non-limiting examples, polypropylene, polyethylene, and perfluoroalkoxy alkanes (PFAs).

The first end cap 115 is connected to one or more of the housing 105, the membrane 110, and core 125, if present. Similarly, the second end cap 120 can be attached to one or more of the housing 105, the membrane 110, and core 125, if present. The first and second end cap can be any suitable material, including, as non-limiting examples, polypropylene, polyethylene, and perfluoroalkoxy alkanes (PFAs). In an embodiment, one or both of the first end cap 115 and the second end cap 120 can be the same material as the housing. The first and second end caps 115, 120 can be attached to housing 105 and optionally other parts using conventional means to create a fluid tight seal and create an integral filter. Non-limiting examples of such attachment include welds such as heat or ultrasonic welds, screw fittings, adhesives, mechanical attachment including seals provided at joints, or the like.

In an embodiment, the first end cap 115 and/or the second end cap 120 includes one or more connectors such as connectors 116, 117. In an embodiment, each of the connectors 116, 117 includes threading surrounding an aperture 119. In embodiments, only two such connectors can be included on each of the end caps, but additional connectors can be provided depending on the application or use of the filter. The threading can allow connection of a fluid line to at least one of the connectors 116, 117. In embodiments, threading can be replaced with any other suitable mechanical connector for forming a sealed connection between fluid lines and the respective connectors 116, 117. The apertures 119 can allow fluid to pass into or out of housing 105, for example to allow fluid that is being filtered to enter or exit the housing 105 or to allow venting of air or any other fluid from the housing 105. In an embodiment, the first end cap 115 can include the connectors 116 for an inlet to allow fluid to be filtered to enter the housing 105 and a vent. The second end cap 120 can include the connectors 117 for an outlet to allow the fluid that has been filtered using membrane 110 to exit the housing 105 and a vent. It is appreciated that the connectors 116, 117 and/or apertures for the inlet and outlet can be provided along different positions of the end cap(s), as necessary for the processing of the fluid. For example, in an embodiment, at least one of the connectors 116, 117 and/or aperture 119 for the inlet and outlet can be provided at a center of the end cap.

The outlet connector 117 can be positioned such that membrane 110 is located within the fluid path from inlet connector 116 to outlet connector 117 through the internal space defined by housing 105 and first and second end caps 115, 120. For example, when the outlet connector 117 is provided at the center of the second end cap 120, the filter is an in-line filter in which the fluid is filtered having an outside-in flow with respect to the membrane 110. The vent connector(s) 116, 117 can allow other fluids to leave housing 105, such as, as a non-limiting example, allowing air to exit the housing 105 when the fluid to be filtered is introduced into a previously unused filter 100. Fluids, including both those filtered by the filter 100 and also other fluids such as the fluid vented at 116, 117 can be in either the gaseous or liquid phase.

As seen in FIG. 1, the filter 100 further includes a baffle 130 that is provided at least partially in the interior space 106, or in a space provided in the first end cap 115, or at the inlet end 107 of the housing 105, or a combination thereof. The baffle 130 seals an open end of the membrane 110 at the inlet end 107 and includes at least two baffle partitions 135 that extend from at least the sealed end of the membrane 110 and along at least a portion of a length of the membrane 110 to divide the interior space 106 of the housing 105 into at least a first portion 106A and a second portion 106B. In an embodiment, the baffle 130 is fluidly connected to the connector 116 to receive the fluid from the inlet and includes an opening 140 which directs the fluid into the first portion 106A of the interior space. It is appreciated that the opening 140 can be provided in the first end cap 115 or in the interior space 106 of the filter housing 105 or a combination thereof.

In an embodiment, the baffle 130 can be connected at the inlet end 107 of the housing 105 and at least connected to the first end cap 115. For example, the baffle 130 can be connected to a portion of the first end cap 115 that forms the aperture 119 using various coupling techniques as known in the art, for example, mechanical connection, e.g., using screw fitting, tabs, or the like, press fitting, heat bonding, welding, including thermal, ultrasonic, or the like, or combinations thereof. The baffle partitions 135 can be connected to the first end cap 115, the baffle 130, the membrane 110, the core 125, and/or a filter cartridge or can be connected to the housing 105, or a combination thereof for dividing the interior space 106 of the housing 105.

The baffle partitions 135 extend from at least the sealed end of the membrane along at least a portion of the length of the membrane 110 that is parallel to a center axis of the filter 100 to divide the interior space 106 into the first portion 106A and the second portion 106B. The baffle partition 135 can also extend at least partially into or to the housing of the first end cap 115. Thus, the baffle partitions 135 are designed to direct the flow of the fluid from the inlet to one side of the filter membrane and to then circulate the fluid on the opposite side of the filter, e.g., creating a circular flow path to the second portion 106B. It is appreciated that by directing the flow of fluid using the baffle partitions 135, low flow, static, or dead zones of fluid in the filter can be removed or reduced when preparing, e.g., conditioning, the filter or during use of the filter. For example, the baffle partitions 135 can extend the entire length of the membrane 110 to a second sealed end surface of the membrane 110. In so doing, after the fluid is directed to the first portion 106A along the outer surface of the membrane 110, the fluid circulates around the membrane 110, e.g., in a space in the second end cap 120 or in the interior space 106 of the housing 105, and directed to flow across the outer surface of the membrane 110 in the second portion 106B. It is appreciated that while the fluid is directed along the outer surface of the membrane 110 in the first portion 106A and the second portion 106B, portions of the fluid are filtered through the membrane 110 so that the permeate can flow through the outlet 117 in the second end cap 120, e.g., along an interior space of the membrane, for example, through the core 125, for discharging the filtered fluid from the filter 100. It is appreciated that in some embodiments, the flow of the fluid can be biased to be filtered through the membrane 110 so that more flow is filtered while the fluid flows in the first portion 106A or the second portion 106B depending on the nature and needs of filtering the fluid. For example, in an embodiment, the core 125 can include larger spaces or holes to allow more flow to flow through the designated portion 106A or 106B to have preferential flow chemistry through the designated portion. It is also appreciated that the membrane can be designed to bias more of the fluid to be filtered, for example, having larger pores which decreases the pressure drop across the membrane at specific portions of the membrane.

In an embodiment, the baffle 130 can include a gap 145 between a bottom surface of the housing of the first end cap 115 and a top portion the baffle partition 135, in which the baffle partition 135 only extends partially into the first end cap 115. The gap 145 is a portion of the baffle partition 135 that does not extend to the bottom surface of the housing of first end cap 115 to allow a fluid communication between the first portion of the interior space 106A and the second portion of the interior space 106B. For example, the baffle partition 135 can have a height equal to the baffle 130 that is connected to the portion of the first end cap 115 that forms the aperture 119. Thus, since the baffle partition 135 does not extend to the domed bottom surface of the first end cap 115, when a fluid is provided through the inlet aperture 119 and directed through the opening 140 of the baffle 130 towards the first portion of the interior space 106A, a venturi/siphoning effect occurs in which the fluid, e.g., stagnant or low flow fluid in the second portion of the interior space 106B, is drawn across the baffle partition 135 and combined with the flow of fluid to the first portion of the interior space 106A to create a circular flow path in the fluid housing. It is appreciated that the gap can be sized to siphon a predetermined volume of flow based on well-known principles of flow dynamics, e.g., based on area and flow velocity, such as Bernoulli’s equation. The gaps can be provided between each baffle partition 135 and the first end cap 115, or the gaps can be apertures in the baffle partition 135, and can be a single gap (or aperture) or multiple gaps (or apertures) having various geometries to control the amount of flow circulated with the first fluid in the first flow path, e.g., siphoned from the second portion of the interior space 106B. That is, the gap(s) or aperture(s) can be structures provided between the baffle and the first end cap 115 or structures provided in the baffle 130 and/or baffle partition 135 that allow fluid communication between the first portion and the second portion of the filter housing through the baffle 130 connected to the first end cap 115, e.g., at or near the inlet flow of the fluid.

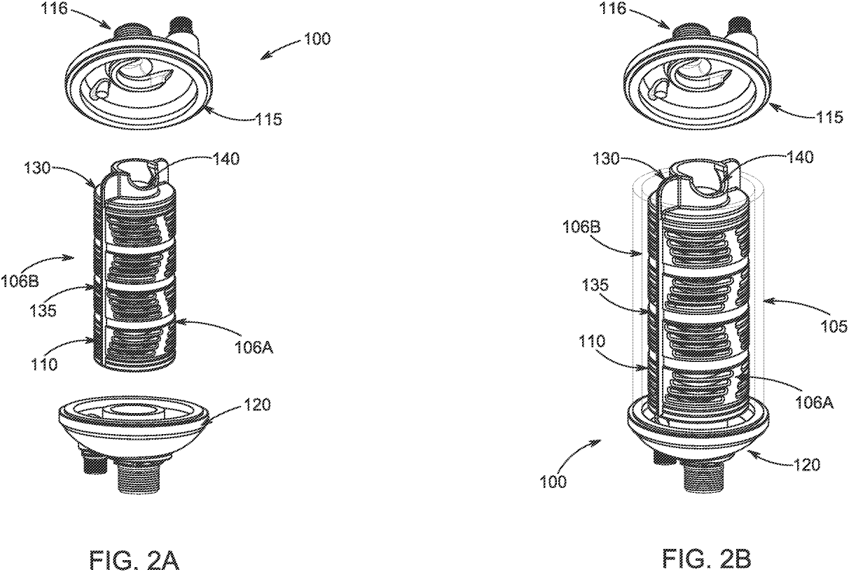

As illustrated in FIGS. 2A and 2B, which show exploded views of the filter 100, the baffle 130 can be a single molded component that includes the baffle 130 and baffle partitions 135, the opening 140, and/or the gap 145. As seen in FIG. 2A, the baffle 130 can also be molded and/or combined with the filter cartridge, e.g., the core 125, the membrane 110, or the like, or molded and/or combined with the housing. FIG. 2B shows that when the baffle 130 is molded and/or combined with the filter cartridge, the combined baffle can be inserted into the housing 105 and sealed with the first end cap 115 and second end cap 120, in which the baffle partitions 135 divide the interior space 106 into the first portion of the interior space 106A and the second portion of the interior space 106B. As discussed above, the baffle 130 can then be connected to a portion of the first end cap 115 that forms the aperture 119 using various coupling techniques as known in the art, for example, mechanical connection, e.g., using screw fitting, tabs, or the like, press fitting, heat bonding, welding, including thermal, ultrasonic, or the like, or combinations thereof. The first and second end caps 115, 120 can be attached to housing 105 and optionally other parts using conventional means to create a fluid tight seal and create an integral filter. Non-limiting examples of such attachment include welds such as heat or ultrasonic welds, screw fittings, adhesives, mechanical attachment including seals provided at joints, or the like.

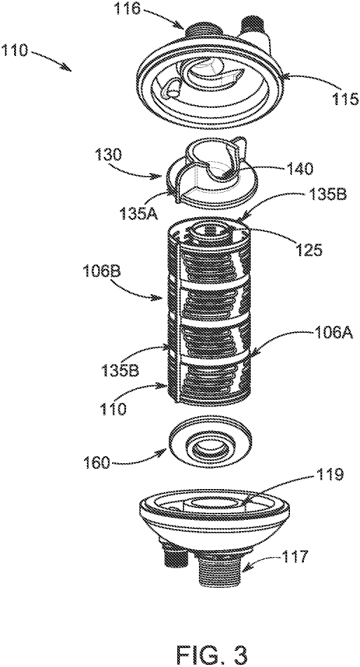

In another embodiment, as seen in FIG. 3, which shows an exploded view of the filter 100, it is also appreciated that the baffle 130 can be constructed as a modular design, in which the several elements can be added together. For example, the baffle 130 can include a plurality of connections for adding additional elements to the baffle 130, e.g., additional baffle partitions 135A, using a coupling technique, for example, slotted tongue and groove connection, press-fit, pin connection, or the like. It is appreciated that the baffle 130 being from a single molded component allows the baffle 130 to be connected to first end cap 115 of a disposable filter during the manufacturing or retrofitting, e.g., being added to an existing design, of a filter 100 and then connected to the filter cartridge that includes the membrane 110 and core 125, in which the filter cartridge can also include baffle partitions 135B for dividing the interior space 106. The baffle partitions 135A and 135B can include connection tabs for connecting the baffle partitions 135A and 135B together. The baffle 130 can be any suitable material, including, as non-limiting examples, polypropylene, polyethylene, and perfluoroalkoxy alkanes (PFAs). Seals can be provided between the different elements of the filter 100. For example, an outlet seal 160 can be provided near the outlet end of the housing connected to the aperture 119 of the outlet connector 117. A seal, for example, a rubber O-ring, can also be provided between the baffle 130 and the filter cartridge and/or the baffle 130 and the first end cap 115 to allow a press-fit connection.

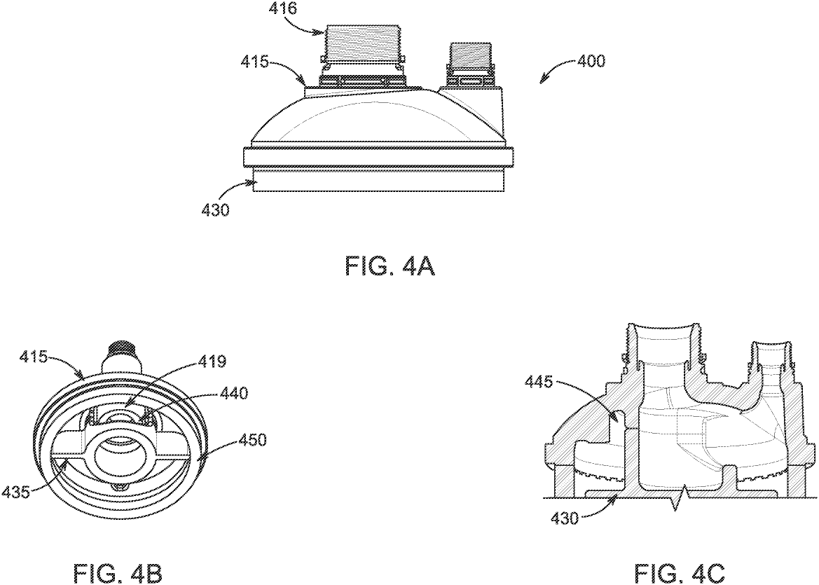

In another embodiment, as seen in FIGS. 4A-4C, a filter 400 includes another design of the baffle 430. The filter 400 of FIGS. 4A-4C includes the same or similar elements and features of the filter 100 shown in FIGS. 1-3, as discussed above, and only shows the first end cap 415 and the baffle 430 in which the baffle partitions 435 do not extend along the entire length of the membrane. Instead, FIGS. 4A and 4B illustrate that the baffle 430 includes an outer circumferential surface 450 that has a length that extends from the first end cap 415 and is provided at least partially in a space in the first end cap 415 or an interior space of the filter or a combination thereof. The baffle 430 is fluidly connected to the connector 416 to receive the fluid from the inlet aperture 419 and further includes an opening 440 which directs the flow of fluid to one side of the filter 400.

The baffle 430 can be connected to the first end cap 415 and connected to or abuts at least one of the inlet end of the housing or the membrane, e.g., filter cartridge. For example, the baffle 430 can be connected to the first end cap 415 forming the aperture 419 and/or the filter cartridge using various coupling techniques as known in the art, for example, mechanical connection, e.g., using screw fitting, tabs, or the like, press fitting, heat bonding, welding, including thermal, ultrasonic, molding, or the like, or combinations thereof.

The baffle partitions 435 are provided at least partially in the end cap 415 or the interior space of the filter housing or a combination thereof and only extend the length of the outer circumferential surface 450 to at least partially divide the interior space of the end cap 415 and/or the interior space of the filter housing into at least a first and second portion. Thus, the flow path of the fluid entering the filter 400 can be made circular using the baffle 430 that is connected to the first end cap 415.

Further, as seen in FIG. 4C, the baffle 430 can include a gap 445 between the first end cap 415 and the baffle partitions 435. In so doing, when the fluid is directed through opening 440 of the baffle 430, the venturi/siphoning effect siphons fluid from the second portion of the baffle 430 to further create a circular flow path to remove or reduce low flow or dead zones in the filter 400. For example, since the baffle partitions 435 extend at least partially into the first end cap 415 and/or the interior space of the housing, when the inlet fluid is directed through opening 440 of the baffle 430 into the first portion, the flow of the fluid follows at least a semi-circular flow path from the first portion to the second portion. Thus, the baffle partitions 435 direct the flow of the fluid from the inlet down one side of the filter membrane and circulate the fluid to the second portion via the gap 445 to create at least the semi-circular flow path. It is appreciated that by directing the flow of fluid in such a manner, low flow, static, or dead zones of fluid flow in the filter can be removed or reduced when preparing, e.g., conditioning, the filter or during use of the filter.

The baffle 430 can be a single molded component including the baffle partitions 435, the opening 440, and/or the gap 445 and connected to the first end cap 415 and/or the filter cartridge. Thus, it is appreciated that the baffle 430 can be connected to first end cap 415 of a disposable filter during the manufacturing or retrofitting, e.g., being added to an existing design, of a filter 400.

While the baffle 130, 430 has been described above as having baffle partitions 135, 435 that are parallel to a center axis of the filter 100, 400, it is appreciated that the baffle 130, 430 can have different designs, e.g., profiles, to modify the flow dynamics of the fluid in the filter 100, 400. For example, the baffle partitions 135, 435 can be straight (or substantially straight), curved, wavy, or the like and can extend substantially parallel to the center axis of the filter or angled to modify the flow dynamics in the filter 100, 400. It is also appreciated that while the baffle partitions 135, 435 have been discussed having two partition plates, the baffle partitions can include additional partition plates as necessary to modify the flow dynamics of the filter to remove or reduce low flow or dead zones in the filter. For example, if the filter 100, 400 includes four baffle partitions 135, 435 and separates the interior space of the housing into four portions, it is understood that at least one of the portions receives the fluid from the inlet of the filter and the fluid is then directed to at least one of the other portions, e.g., in counter flow and/or parallel flow arrangements.

A method of filtering a fluid by creating circular flow patterns in the in-line filter using the baffle is described below. Referring back to FIG. 1, in an embodiment, the filter 100 receives a fluid to be filtered at the inlet aperture 119. One end of the baffle 130 having the opening 140 is connected to the inlet aperture 119 of the first end cap 115 and the other end abuts or is connected to an end sealed surface of the membrane and/or the core so that the fluid is directed through the opening 140 of the baffle 130. The baffle 130 includes at least two baffle partitions 135 that extend along a length of the membrane 110 and divide the interior of the housing into at least a first portion 106A and a second portion 106B. Thus, the baffle opening 140 directs the flow of fluid towards at least the first portion 106A of the interior space 106.

The fluid flows across the outer surface of the membrane 110 (filtering at least a part of the fluid) in the first portion 106A to the end of the membrane 110 in a direction parallel to the center axis of the filter. The fluid then flows around the membrane 110, either within the filter housing and/or in the second end cap 120, and then flows in a counter flow direction across the outer surface of the membrane 110 in the second portion 106B. As the fluid is filtered through the membrane 110, the filtrate flows towards the outlet aperture of the filter 100 in the second end cap 120.

It is appreciated that in the embodiment in which the baffle 130 includes the gap(s) 145 at the end of the baffle partitions 135, the flow of the fluid through the opening 140 towards at least the first portion 106A creates a venturi/siphoning effect that pulls fluid from the opposite side of the baffle partition into the incoming fluid stream towards the first portion 106A to further create a circular flow path in the filter housing. It is appreciated that such affect further removes or reduces the low flow or dead zones in the filter.

By creating the circular flow path in the filter housing, it was surprisingly found that the improvement of the distribution and flow of the fluid improves the exchange of chemistries of the filter membrane, which not only improves the efficiency of the flushing and the cleaning of the filter during the preparation of the filter, and but also improves the residence time of the fluid during use of the filter and preventing the accumulation of residual chemistries and/or contaminants by at least preventing or reducing low flow or dead zones in the filter housing. In prior designs of the filter, areas of low flow or stagnant flow existed in areas of the interior space that were between the filter cartridge and the housing including the second end cap and/or the first end cap. For example, the prior design of the in-line filter had about 15% of the flow zone in the interior space as stagnant or low flow, e.g., < 0.05 cm/sec at 3 liters per minute. The filters as disclosed herein, however, that have the circular flow path, were found to reduce or eliminate the areas in the interior space that have low flow or stagnant flow to less than 10%, preferably less than 8% and most preferably less than 6% of the interior space having such low flow or stagnant flows. That is, since the fluid flows through at least a portion of the second end cap to flow to the second portion of the interior of the housing, the areas of low or stagnant flow that were previously provided in the prior filters are reduced. Since low flow or dead zones in a filter, e.g., flows that are less than about 0.05 cm/sec, may leave residual chemistries or contaminants that may accumulate and/or provide areas of bacterial growth and/or not utilize the entirety of the filter membrane and/or has too much residence time of the fluid, the preparation and use of the filter can be improved by such improved flow patterns.

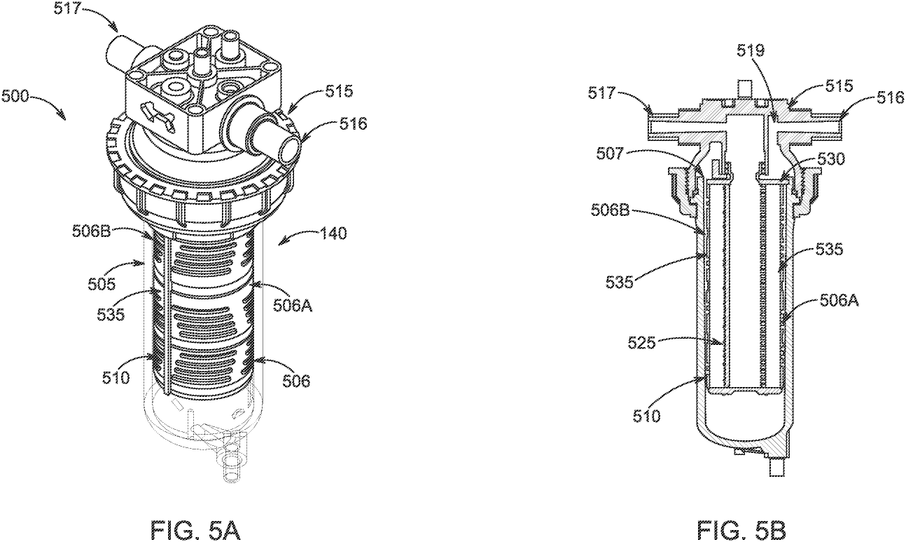

In yet another embodiment of the invention, as seen in FIGS. 5A and 5B, filter 500 is provided as a T-line reusable filter, in which the baffle 530 is provided entirely in the housing 505. The filter 500 of FIGS. 5A-5B includes the same elements and features of the filters discussed above, in which like elements and materials are not repeated. The filter 500 includes the housing 505 having an interior space 506, in which the housing 505 includes an open end 507. The filter 500 further includes a membrane 510 disposed in the interior space 506 of the housing and a cap 515 connected to the open end 507. The cap 515 can further define the interior space 506 of the housing. As shown, in FIG. 5B, in some embodiments, the filter may also include a core 525 about which the membrane 510 is disposed. In other embodiments, the core 525 can be omitted. The interior space 506 can accommodate the different elements of the filter, for example, the membrane 510 and optionally the core 525, along with a fluid being filtered using the membrane 510.

The cap 515 is connected to one or more of the housing 505, the membrane 510, and core 525, if present. The cap 515 can be attached to housing 505 and optionally other parts using conventional means to create a fluid tight seal and create an integral filter. Non-limiting examples of such attachment include welds such as screw fittings, snap-fittings, mechanical attachment including seals provided at joints, or the like. Such attachments allow the reusable use of the filter 500.

In an embodiment, the cap 515 includes one or more connectors such as connectors 516, 517. In an embodiment, each of the connectors 516, 517 includes a tubing connector surrounding an aperture 519, in which the tubing connector can be threads for a screw fitting, snap-fitting, press-fittings, or the like. In embodiments, only two such connectors can be included on the cap, but additional connectors can be provided depending on the application or use of the filter. The tubing connector can allow connection of a fluid line to at least one of the connectors 516, 517. The apertures 519 can allow fluid to pass into or out of housing 505, for example to allow fluid that is being filtered to enter or exit the housing 505 or to allow venting of air or any other fluid from the housing 505. In an embodiment, the cap 515 can include the connector 516 for an inlet to allow fluid to be filtered to enter the housing 505 and a vent. The cap 515 can include the connector 517 for an outlet to allow the fluid that has been filtered using membrane 510 to exit the housing 505 and a vent. It is appreciated that the connectors 516, 517 and/or apertures for the inlet and outlet can be provided along different positions of the end cap, as necessary for the processing of the fluid.

The outlet connector 517 can be positioned such that membrane 510 is located within the fluid path from inlet connector 516 to outlet connector 517 through the internal space defined by housing 505 and the cap 515. For example, the outlet connector 517 is connected to the center of the cap 515, so that the filter is a T-line filter in which the fluid is filtered having an outside-in flow with respect to the membrane 510.

As seen in FIGS. 5A-5B, the filter 500 further includes a baffle 530 that is provided in the interior space 506. The baffle 530 seals an open end of the membrane 510 at the open end 507 and includes at least two baffle partitions 535 that extend from at least the sealed end of the membrane 510 and along at least a portion of a length of the membrane 510 to divide the interior space 506 of the housing 505 into at least a first portion 506A and a second portion 506B. In this embodiment, the baffle 530 also includes an opening 531 provided centrally of the baffle 530 for the exit of the fluid to the outlet connector 517. The baffle 530 can be connected at the open end 507 of the housing 505 and at least connected to the cap 515. For example, the baffle 530 can be connected to a portion of the cap 515 that forms the aperture 519 connected to the outlet connector 517 using various coupling techniques as known in the art, for example, mechanical connection, e.g., using screw fitting, tabs, press fitting, or the like, or combinations thereof. The baffle partitions 535 can be connected to the baffle 530, the membrane 510, the core 525, and/or a filter cartridge, or can be connected to the housing 505, or a combination thereof, to divide the interior space of the housing. That is, in some embodiments, the baffle 530 can be provided on the filter cartridge for insertion into the housing 505 and/or provided attached to the housing 505 itself.

The baffle partitions 535 extend from at least the sealed end of the membrane along at least a portion of the length of the membrane 510 that is parallel to a center axis of the filter 500 to divide the interior space 506 into the first portion 506A and the second portion 506B. In an embodiment, the baffle partition 535 can also extend at least partially into or to the housing of the first end cap 515. Thus, the baffle partitions 535 are designed to direct the flow of the fluid from the inlet to one side of the filter membrane and to circulate the fluid on the opposite side of the filter, e.g., to create a circular flow path to the second portion 506B. It is appreciated that by directing the flow of fluid using the baffle partitions 535, low flow, static, or dead zones of fluid in the filter can be removed or reduced when preparing, e.g., conditioning, the filter or during use of the filter to decrease residence time of the fluid. For example, the baffle partitions 535 can extend the entire length of the membrane 510 to a second sealed end surface of the membrane 510. In so doing, after the fluid is directed to the first portion 506A along the outer surface of the membrane 510, the fluid circulates around the membrane 510, e.g., in a space in the interior space 506 of the housing 505, and directed to flow across the outer surface of the membrane 510 in the second portion 506B. It is appreciated that while the fluid is directed along the outer surface of the membrane 110 in the first portion 506A and the second portion 506B, portions of the fluid are filtered through the membrane 510 so that the permeate can be directed to the outlet 517 in the second end cap 520, e.g., along an interior space of the membrane, for example, through the core 525, for discharging the filtered fluid from the filter 100. Similar to the embodiments as discussed above, it is appreciated that the filtering of the fluid can be biased to be filtered while flowing past the first or second portion 506A, 506B depending on the application of the filter and fluid to be filtered. Thus, the baffle 530 is fluidly connected to the connector 516 to receive the fluid from the inlet, in which the baffle partitions 535 direct the fluid into the first portion 506A of the interior space, and the permeate is filtered through the core 525 to exit the filter 500 through the opening 531 and the connector 517.

Accordingly, a filter that uses the embodiments of the baffle discussed herein results in a filter having improved flow patterns in which areas of low flow or dead zones, e.g., stagnant flow or no flow, are reduced or removed in different portions of the interior space of the filter, and especially between the membrane and the housing and the second end cap.

### Aspects

It is understood that any of aspects 1-12 can be combined with any of aspects 13-16 or 17. It is understood that any of aspects 13-16 can be combined with any of aspects 1-12 or 17.

Aspect 1. A filter comprising: a housing having an interior space, the housing comprising at least one opening end; a membrane disposed within the housing that has a length that extends along a length direction of the housing, and a baffle provided at least in the interior space of the housing, wherein the baffle comprises at least two baffle partitions that extend along at least a portion of the length of the membrane to divide the interior space of the housing into at least a first portion and a second portion so that when a fluid is supplied to the filter, the fluid is directed to first flow in the first portion and then to the second portion.

Aspect 2. The filter according to aspect 1, further comprising a first end cap connected to the at least one opening end, wherein the baffle is also provided in the first end cap and is at least connected to the first end cap of the filter.

Aspect 3. The filter according to aspect 2, wherein a gap is provided between the at least two baffle partitions and a bottom surface of the first end cap.

Aspect 4. The filter according to any of aspects 2 or 3, wherein the first end cap comprises a first aperture for receiving the fluid, wherein the baffle comprises an opening that is in fluid communication with the first aperture, wherein the inlet is configured to direct the fluid to the first portion of the interior space.

Aspect 5. The filter according to aspect 4, wherein the first end cap further comprises a second aperture acting as a vent.

Aspect 6. The filter according to any of aspects 2-5, wherein the baffle is configured in a way such that a flow of fluid is directed to flow along an outer surface of the membrane.

Aspect 7. The filter according to any of aspects 2-6, further comprising a second opening end of the housing and a second end cap provided at the second opening end of the housing and comprising a third aperture for discharging the fluid filtered through the membrane.

Aspect 8. The filter according to aspect 7, wherein the third aperture is provided at a center of the second end cap.

Aspect 9. The filter according to any of aspects 2-8, wherein the at least two baffle partitions each comprise a first end provided near or adjacent to or in the first end cap and a second end that extends only to an end of the membrane in the housing.

Aspect 10. The filter according to any of aspects 1-9, further comprising a core disposed within the housing wherein the membrane is positioned between the core and the housing.

Aspect 11. The filter according to any of aspects 1-10, baffle is only provided in the interior space of the housing and the baffle further comprises an opening provided centrally in the baffle, and the filter further comprising a cap connected to the at least one opening end, wherein the cap includes an inlet for receiving the fluid and an outlet fluidly connected with the opening of the baffle for removing the fluid from the filter.

Aspect 12. The filter according to any of aspects 1-11, wherein the baffle is provided in a way such that low flow zones of the fluid between the membrane and the housing are minimized.

Aspect 13. A filter housing, comprising: an inlet end; an outlet end formed on an opposite end of the housing than the inlet end; an interior space; and a baffle provided at least in the interior space of the housing and at the inlet end, wherein the baffle comprises at least two baffle partitions that extend along at least a portion of a length of the filter housing to divide the interior space of the housing into at least a first portion and a second portion so that when a fluid is supplied to the filter housing, the fluid is directed to first flow along the first portion and then to the second portion.

Aspect 14. The filter housing of aspect 13, further comprising a first end cap connected to the inlet end of the filter housing, wherein the baffle is at least connected to the first end cap of the filter housing.

Aspect 15. The filter housing of aspect 14, wherein a gap is provided between the at least two baffle partitions and a bottom surface of the first end cap.

Aspect 16. The filter housing of any of aspects 13-15, wherein the baffle is provided in a way such that low flow zones of the fluid in the housing are minimized.

Aspect 17. A method of filtering a fluid, comprising: introducing the fluid into a filter through an inlet; directing the fluid through a baffle formed in an interior of a housing of the filter, the baffle comprising at least two baffle partitions that extend along at least a portion of the length of the membrane to divide an interior of the housing into at least a first portion and a second portion, passing the fluid through the baffle and the at least two baffle portions so that the fluid is directed to first flow in the first portion and then to the second portion, wherein the fluid is passed through a membrane of the filter to an outlet.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. Changes may be made in details, particularly in matters of shape, size, and arrangement of parts without exceeding the scope of the disclosure. The disclosure’s scope is, of course, defined in the language in which the appended claims are expressed.

What is claimed is:

1. A filter comprising:
a housing having an interior space, the housing comprising at least one opening end;
a membrane disposed within the housing that has a length that extends along a length direction of the housing, and
a baffle provided at least in the interior space of the housing, wherein the baffle comprises at least two baffle partitions that extend along at least a portion of the length of the membrane to divide the interior space of the housing into at least a first portion and a second portion so that when a fluid is supplied to the filter, the fluid is directed to first flow in the first portion and then to the second portion.

2. The filter of claim 1, further comprising a first end cap connected to the at least one opening end of the housing, wherein the baffle is also provided in the first end cap and is at least connected to the first end cap.

3. The filter of claim 2, wherein a gap is provided between the at least two baffle partitions and a bottom surface of the first end cap.

4. The filter of claim 2, wherein the first end cap comprises a first aperture for receiving the fluid, wherein the baffle comprises an opening that is in fluid communication with the first aperture, wherein the inlet is configured to direct the fluid to the first portion of the interior space.

5. The filter of claim 4, wherein the first end cap further comprises a second aperture acting as a vent.

6. The filter of claim 2, wherein the baffle is configured in a way such that a flow of fluid is directed to flow along an outer surface of the membrane.

7. The filter of claim 4, further comprising a second opening end of the housing and a second end cap provided at the second opening end of the housing and comprising a third aperture for discharging the fluid filtered through the membrane.

8. The filter of claim 7, wherein the third aperture is provided at a center of the second end cap.

9. The filter of claim 2, wherein the at least two baffle partitions each comprise a first end provided near or adjacent to or in the first end cap and a second end that extends only to an end of the membrane in the housing.

10. The filter of claim 1, further comprising a core disposed within the housing wherein the membrane is positioned between the core and the housing.

11. The filter of claim 1, wherein the baffle is only provided in the interior space of the housing and the baffle further comprises an opening provided centrally in the baffle, and the filter further comprising a cap connected to the at least one opening end, wherein the cap includes an inlet for receiving the fluid and an outlet fluidly connected with the opening of the baffle for removing the fluid from the filter.

12. The filter of claim 1, wherein the baffle is provided in a way such that low flow zones of the fluid between the membrane and the housing are minimized.

13. A filter housing, comprising:
an inlet end;
an outlet end formed on an opposite end of the housing than the inlet end;
an interior space; and
a baffle provided at least in the interior space of the housing and at the inlet end, wherein the baffle comprises at least two baffle partitions that extend along at least a portion of a length of the filter housing to divide the interior space of the housing into at least a first portion and a second portion so that when a fluid is supplied to the filter housing, the fluid is directed to first flow along the first portion and then to the second portion.

14. The filter housing of claim 13, further comprising a first end cap connected to the inlet end of the filter housing, wherein the baffle is at least connected to the first end cap of the filter housing.

15. The filter housing of claim 14, wherein a gap is provided between the at least two baffle partitions and a bottom surface of the first end cap.

16. The filter housing of claim 14, wherein the baffle is provided in a way such that low flow zones of the fluid in the housing are minimized.

17. A method of filtering a fluid, comprising:
introducing the fluid into a filter through an inlet;
directing the fluid through a baffle formed in an interior of a housing of the filter, the baffle comprising at least two baffle partitions that extend along at least a portion of the length of the membrane to divide an interior of the housing into at least a first portion and a second portion,
passing the fluid through the baffle and the at least two baffle portions so that the fluid is directed to first flow in the first portion and then to the second portion,
wherein the fluid is passed through a membrane of the filter to an outlet.
